(19) United States
(12) Patent Application Publication
(10) Pub. No.: US 2013/0031083 A1
(43) Pub. Date: Jan. 31, 2013

(54) Determining keyword for a form page

(71) Applicants: Jayant Madhavan, Fremont, CA (US); David Ko, San Lorenzo, CA (US); Lucja A. Kot, Lansing, NY (US); Alon Halevy, Los Altos, CA (US)

(72) Inventors: Jayant Madhavan, Fremont, CA (US); David Ko, San Lorenzo, CA (US); Lucja A. Kot, Lansing, NY (US); Alon Halevy, Los Altos, CA (US)

(21) Appl. No.: 12/062,274

(22) Filed: Apr. 3, 2008

Related U.S. Application Data
(63) Continuation-in-part of application No. 11/872,621, filed on Oct. 15, 2007.

(51) Int. Cl. G06F 7/06; G06F 17/30

(52) U.S. Cl. 707/713; 707/E17.017; 707/731; 707/741

(57) ABSTRACT

Among other disclosed subject matter, a computer-implemented method of analyzing a form page for indexing includes identifying a form page that is configured for use in requesting any of multiple target pages, the form page including at least one text input control for retrieving any of the multiple target pages. The method includes identifying at least one keyword as being informative with regard to the text input control. The method includes updating an indexing record associated with the form page to reflect the identified keyword.

### CROSS-REFERENCE TO RELATED APPLICATION

This application claims priority from pending U.S. patent application Ser. No. 11/872,621, entitled “Analyzing a Form Page for Indexing” and filed on Oct. 15, 2007, the contents of which are incorporated herein by reference.

### TECHNICAL FIELD

This document relates to determining at least one keyword for a form page.

### BACKGROUND

There are many HTML forms used on the World Wide Web (WWW). HTML forms require users who want access to the content behind the form to fill in or select values for one or more different input fields in the form and make a submission. The pages resulting from such submissions can be very useful to web users. The content that lies hidden behind such forms is enormous by some estimates. This notion is often referred to by the terms Deep Web, Hidden Web or Invisible Web.

However, result pages obtained from a form page may not be indexed by search engines if the web-crawler does not have the ability to automatically fill out HTML forms. As such, the web crawler may not be able to detect the hidden pages. This presents a gap in the coverage of search engines (and hence the names Hidden, Deep or Invisible Web for such content).

An approach of creating URLs corresponding to all possible combinations of input-values can provide either or both of the following results. First, no valid HTML page may exist for the URL created by appending input-name-value pairs to the form action. Second, because there may be numerous possible combinations of input values for the different input fields, it is possible that a very large number of URLs must be created (corresponding to each submission of a combination of input values). For example, cars.com has an inventory of about 50,000 cars, but the number of possible form submissions for their search page on www.cars.com is more than a million.

Some online forms have text inputs that play a role in the decision which of the underlying pages is or are to be displayed in response to an input. In such forms, appropriate values may be required for the text input to generate a valid form submission.

### SUMMARY

The invention relates to determining an informative keyword for a form page.

In a first aspect, a computer-implemented method of analyzing a form page for indexing includes identifying a form page that is configured for use in requesting any of multiple target pages, the form page including at least one text input control for retrieving any of the multiple target pages. The method includes identifying at least one keyword as being informative with regard to the text input control. The method includes updating an indexing record associated with the form page to reflect the identified keyword.

Implementations can include any, all or none of the following features. Identifying the keyword as being informative can include generating a first set of page identifiers, each of the page identifiers including at least one of a number of keywords; retrieving any of the multiple target pages that are obtained using any of the generated first set of page identifiers; and analyzing the retrieved target pages with regard to a predefined difference standard. The analysis can indicate that one of the retrieved target pages obtained for the keyword satisfies the difference standard relative to others of the retrieved pages, and the indexing record can be updated to reflect that the keyword is informative with regard to requesting the multiple target pages. The analysis can indicate that one of the retrieved target pages obtained for another keyword does not satisfy the difference standard relative to others of the retrieved pages, and the indexing record can be updated to reflect that the other keyword is not informative with regard to requesting the multiple target pages. The method can further include extracting at least the keyword from the form page before identifying it as informative. Extracting the keyword can include analyzing content of the form page using an importance measure; and extracting any word in the content that satisfies an importance criterion of the importance measure. Identifying the keyword as being informative can include performing a first processing of the text input control as a generic text input control; and performing a second processing of the text input control as a typed text input control; wherein the identification of the keyword is based at least in part on the first and second processings. The identification of the at least one keyword as informative can include an iterative process that includes at least two iterations. A previous iteration of the iterative process can yield a set of keywords, and each iteration can include narrowing down the set of keywords obtained in the previous iteration; entering the narrowed set of keywords using the text input control of the form page; and extracting a new set of keywords from at least one of the multiple target pages obtained in response to entering the narrowed set of keywords. A set of keywords, including the at least one keyword, can be identified as being informative with regard to requesting the multiple target pages. The method can further include updating the indexing record associated with the form page to reflect the identified set of keywords, wherein the indexing record is used over a period of time by a search engine performing searches for users; and tracking any search requests received by the search engine that implicate any of the set of keywords. The method can further include analyzing the tracked search requests; and revising the set of keywords reflected in the indexing record based on the analyzing. When the analysis shows that more than a threshold portion of the set of keywords are implicated by the search requests, the method can further include obtaining at least one additional keyword for the form page that is not included in the set of keywords; and updating the indexing record to reflect also the at least one additional keyword. When the analysis shows that less than a threshold portion of the set of keywords are implicated by the search requests, the method can further include updating the indexing record to reflect fewer than all of the identified set of keywords. A number of keywords can be obtained before identifying the set of keywords as being informative, and the method can further include obtaining the set of keywords including reducing the number of keywords. The number of keywords can be reduced by: analyzing those of the multiple target pages obtained using each of the keywords; and eliminating any keyword for which the obtained pages do not produce any new keyword that is not already included in the number of keywords. The number of keywords can be reduced including: determining multiple page signatures, one for each of the multiple target pages obtained using any of the number of keywords; clustering each of the number of keywords based on the page signatures; and selecting the set of keywords based on the page signatures. The page signature can include information about a length of each of the multiple target pages obtained using any of the number of keywords, and the set of keywords can be selected in order of size beginning with one of the multiple target pages having a greatest length. The method can further include selecting a plurality of types of keyword domains before identifying the keyword as being informative; entering keywords selected from the plurality of types of keyword domains in the text input control of the form page; evaluating at least one of the multiple target pages obtained in response to entering the narrowed number of keywords; and determining, based on the evaluation, whether any of the plurality of types of keyword domains should be used as keywords for the form page. At least one of the plurality of types of keyword domains can include a finite domain, and the keywords can be selected by sampling the finite domain. At least one of the plurality of types of keyword domains can include a continuous domain, and the selected keywords can be uniformly distributed in the continuous domain.

In a second aspect, a computer program product is tangibly embodied in a computer-readable storage medium and includes instructions that when executed by a processor perform a method for analyzing a form page for indexing. The method includes identifying a form page that is configured for use in requesting any of multiple target pages, the form page including at least one text input control for retrieving any of the multiple target pages. The method includes identifying at least one keyword as being informative with regard to entering the at least one keyword in the text input control for requesting the multiple target pages. The method includes updating an indexing record associated with the form page to reflect the identified keyword.

In a third aspect, a computer-implemented method of analyzing a form page for indexing includes identifying a form page associated with multiple target pages, the form page including at least one text input control. The method includes determining, regarding an indexing to be performed, whether the text input control should be processed as a typed text input control or as a generic text input control in the indexing. The method includes recording at least one keyword in an indexing record associated with the form page based on the determination, the indexing record configured for use in the indexing.

Advantages of implementations can include any, all or none of the following. Search engine indexing can be improved, for example by including web pages that result from submissions on a form page. A form page can be processed more efficiently by determining whether a text input control on the form page is informative with regard to obtaining underlying pages, and/or an informative property of a keyword to be entered on the page can be determined. A set of one or more keywords and/or values can be determined that can be used to generate URLs for pages underlying a form page. Indexing records can be generated that reflect relevant aspects of a form page. The number of URLs fetched by a web crawler of a search engine can be reduced, since indexing records can reflect only the informative relevant aspects of a form page.

The details of one or more embodiments are set forth in the accompanying drawings and the description below. Other features and advantages will be apparent from the description and drawings, and from the claims.

### DESCRIPTION OF DRAWINGS

FIG. 1 shows an example of a block diagram of a system that can analyze a form page for indexing.

FIG. 1A shows an example distribution histogram of HTML forms by the number of keywords selected for each form.

FIG. 1B shows an example database coverage table that relates text boxes on forms with URLs obtained using the text boxes.

FIG. 2 shows a flow chart of an example method for analyzing a form page for indexing.

FIG. 3 shows another flow chart of an example method for analyzing a form page for indexing.

FIG. 4 is a block diagram of a computing system that can be used in connection with computer-implemented methods described in this document.

Like reference symbols in the various drawings indicate like elements.

### DETAILED DESCRIPTION

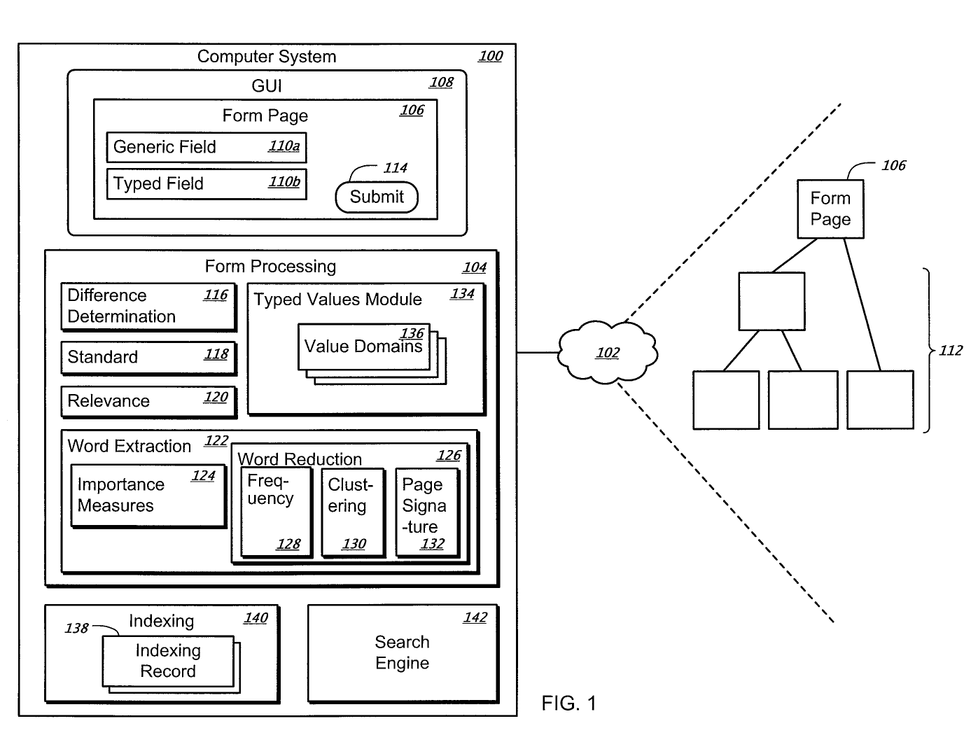

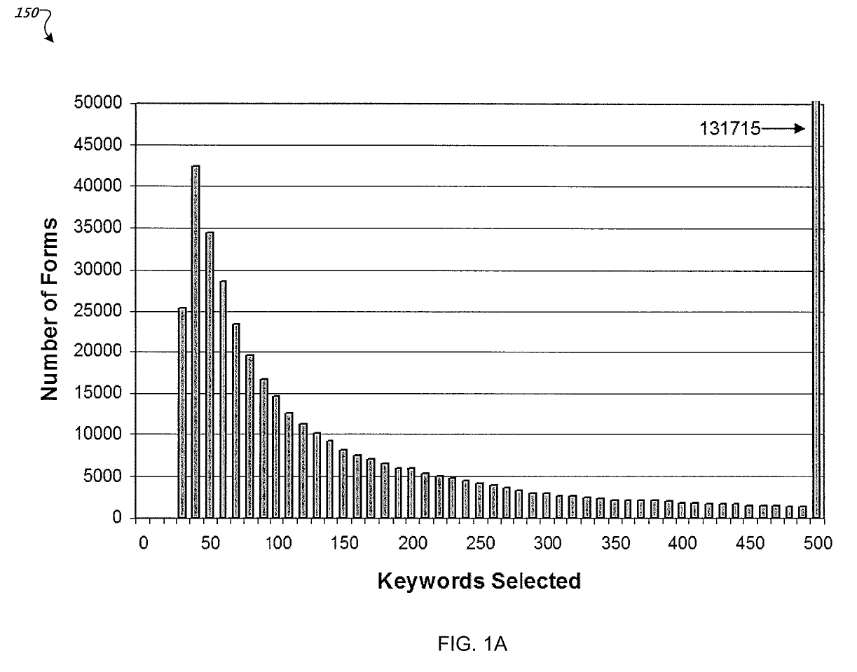

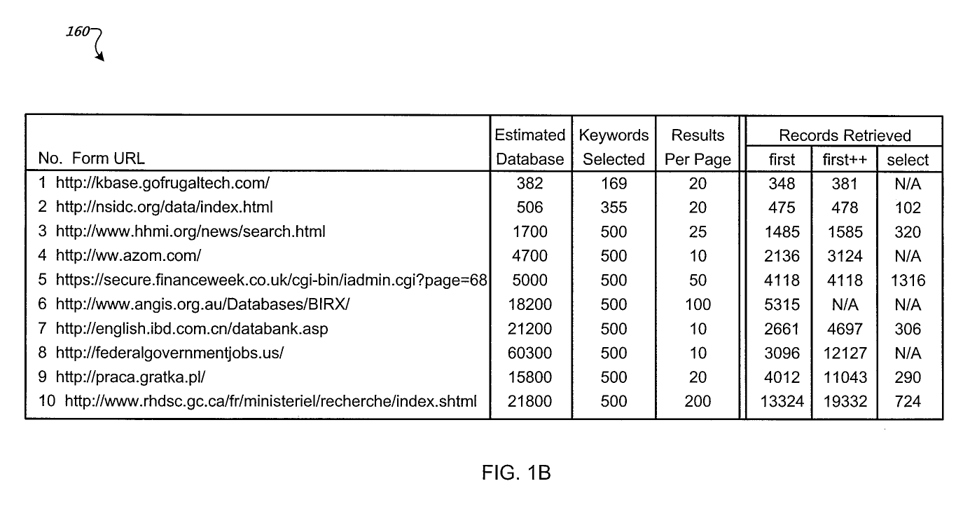

FIG. 1 shows an example of a block diagram of a system 100 that can analyze a form page or other content for indexing. For example, the system 100 can be configured to perform indexing on pages available in a computer network 102, such as on the Internet, based on a list of uniform resource locators (URLs) for the pages that are to be indexed. Using the list of URLs, the system 100 can retrieve content from the corresponding pages and index that content. Such a created index can for example be used by a search engine to provide results to a query entered by a user. Particularly, in some implementations the system 100 can identify a form page, such as an Internet page with HTML code that generates a form to be completed by a user, that serves as an entryway to a number of other pages. For such a form page, the system 100 can for example determine whether a text input control on the page is a generic text input control or a typed text input control. As another example, the system 100 can determine whether any or all text input controls are informative with regard to retrieving the underlying pages. As another example, one or more keywords for the text input control can be determined. In some implementations, the keywords are identified as being informative with regard to requesting the other pages. For example, a keyword can be deemed informative if entering it on the page provides a page that is sufficiently different from pages that are retrieved when other keywords are entered on the page. As such, the informative keyword can be said to be one that is helpful to use for indexing, in that it generates a page that one may want to include in an indexing record.

In some implementations, the processing of the form page(s) seeks to determine more information about the form page and this knowledge can be used so that those of the underlying pages that are good to use for indexing can be retrieved upon request. For example, a page may be useful for indexing if it is unique compared to other pages or if it is representative of one or more other pages. By similar token, input controls that retrieve underlying pages can be good to use for indexing if they are informative with regard to the pages; if they are selective when it comes to page retrieval; or if they produce pages that are non-redundant with regard to each other, to name a few examples.

For this and other purposes, the system 100 here includes a form processing module (FPM) 104. For example, the FPM 104 can analyze one or more of the form pages 106 and determine one or more keywords. When presented in a graphical user interface (GUI) 108, the form page 106 can provide one or more text input controls 110a and 110b operable by a user. Other architectures than the one shown can be used.

In some implementations, the system 100 identifies that the form page 106 is to be processed for indexing. That is, the form page can be associated with multiple underlying target pages, and the indexing can be performed on one or more of them. The system 100 can therefore invoke the FPM 104 which, in some implementations, determines whether any or all text input controls on the form page should be processed as a typed text input control or as a generic text input control in the indexing. The FPM 104 can also record at least one keyword in an indexing record associated with the form page based on the determination. Such an indexing record can be configured for use in the indexing, for example to contain one or more identified words to be input on the form page to retrieve an underlying page or pages.

As depicted, the text input control 110a is a generic field, accepting any kind of textual input (e.g., a book title) from a continuous (or unlimited) domain. By contrast, the text input control 110b is a typed field, accepting values that depend on the finite (or limited) domain of valid values for that type (e.g., 5-digit numbers for ZIP codes, 2-character abbreviations for U.S. states, etc.).

A user of the system 100 may employ any number of text input controls 110a and 110b, for example to browse products or services accessible from the form page 106. For example, the form page 106 can be published by a car manufacturing company to allow online users to browse a wide selection of car models, configurations and optional vehicle choices that the company offers its customers. As such, the form page 106 can be considered an entryway to, in this example, a large number of pages 112. Particularly, the pages 112 can correspond to particular keywords entered in either or both of the text input controls 110a and 110b. That is, each one of the pages 112 can be designed for a specific choice of vehicle model, configuration and options, and a user can reach this page by selecting those settings using the text input controls 110a and 110b and activating a Submit control 114. When reaching the individual page, then, the user can be presented with information and/or images, to name a few examples, of the vehicle according to the input values that the user entered.

The number of the pages 112 that exist can be different. The number of the text input controls 110a and 110b and/or how many alternative input values each one of them accepts can also vary in different examples. In some implementations, the pages 112 can range in the number of millions of pages or more. From an indexing perspective, it can be of interest to catalogue the pages 112 in as representative a way as possible. In some situations, this can drive the effort towards indexing pages for all of the possible combinations of settings in the text input controls 110a and 110b.

However, in some examples some or many of the pages 112 are identical or very similar to each other. For example, two pages depicting selectable configurations of a car can differ in the color of seat fabric for the vehicle but otherwise be identical. Moreover, it is possible that no page exists for certain combinations of the possible keywords entered in the text input controls 110a and 110b. To continue the example with the form page from the vehicle manufacturer, some configurations or options may not be offered with certain models of cars, and these “invalid” combinations of input values therefore have no corresponding page among the pages 112. For example, the generic field associated with the text input control 110a accepts an essentially unlimited number of keywords, of which less than all may correspond to actual pages. In some implementations, the total universe of theoretical settings of the text input controls 110a and 110b need therefore not be an indication of how many of the pages 112 must be considered to obtain a representative view of the entire collection.

The FPM 104 can analyze the form page 106 in an attempt to identify one or more keywords for the text input controls 110a and 110b. In some implementations, the FPM 104 determines which of the controls 110a and 110b is or are informative relative to the pages underlying the form page 106. In other implementations, the FPM 104 can identify one or more keywords that are to be used with at least one of the input controls 110a and 110b during indexing. For example, a keyword can be identified as being informative for a text input control if a substantially different page can be retrieved using that keyword as compared to those retrieved using other keywords. As another example, the text input control itself can be deemed informative if keywords can be chosen such that the URLs generated by the chosen keywords retrieve a sufficient pre-determined number of pages with distinct content.

The comparison of the various pages 112 can be performed in a difference determination 116 that in this example is part of the FPM 104. For example, the difference determination 116 can involve computing a signature for each web page in the generated collection. The FPM 104 can apply the difference determination 116 to two or more retrieved pages to decide if they are sufficiently similar, or sufficiently different, according to a standard 118. For example, if the difference of two compared pages does not rise to the level required by the standard 118, the pages can be deemed similar by the FPM 104. As another example, if the difference of two compared pages meets or exceeds the level required by the standard 118, the pages can be deemed different by the FPM 104. The number of distinct signatures in the collection can then be counted.

There are many possible choices for computing signatures, including, but not limited to:
Analyzing or considering the entire HTML code for the webpage. For example, this approach can involve parsing the HTML code of the respective pages and deriving a fingerprint measure from it that is indicative of the page content. In some implementations, this approach requires that formatting included in the code be removed to ensure that it does not interfere with the processing. For example, an approximate fingerprint measure can be obtained by attempting to ignore HTML boilerplate content while parsing contents of the page.
Analyzing or considering only the textual content of the retrieved pages, i.e., the words that are visible to the user. In some implementations, this approach can result in false or misleading results due to, for example, less relevant text such as advertisements or banners.
Extracting words from the pages that are most relevant to the pages' content. For example, this can be done by analyzing frequency of words, such as whether they occur often or seldom; placement of words, such as whether they occur in titles or headlines; emphasis of words, such as whether they are capitalized or highlighted. This analysis of the difference in content can be determined by extracting words from the retrieved multiple pages according to a relevancy criterion 120. Based on an analysis of the words, a short signature can be created that summarizes the page's HTML text.

The analysis of page distinctiveness having been done, the keyword(s) can then be recorded in an indexing record associated with the form page. In some implementations, a set of keywords can be deemed informative with regard to retrieving the pages underlying a form page using a text input control if the number of distinct page signatures is at least 25% of the total number of retrieved pages. This can for example be the case when 100 pages can be generated using the set of keywords and there are at least 25 of these pages that have distinct web page signatures. Other definitions for the informative property based on the contents of the generated pages can be used. Once page distinctness determination is completed, the system 100 can identify keywords for indexing, for example as will now be described.

The FPM 104 includes a word extraction module 122 that can extract one or more candidate keywords from form page 106. In some implementations, the word extraction module 122 can extract keywords from words appearing on the form page 106. For example, the word extraction module 122 can extract one or more keywords associated with automobile makes or models.

The word extraction module 122 can use a set of importance measures 124. The importance measures 124 can include multiple importance criteria that are used to determine the importance of a word to be extracted. For instance, the importance measures 124 can include measures and/or thresholds for selecting words based on the frequency of the word on the form page 106, the placement of the words (e.g., whether they occur in titles, headlines, as defaults in text input controls, etc.), the emphasis of words (e.g., whether they are capitalized or highlighted), to name a few examples. The importance measures 124 can also make use of the number and uniqueness of form pages obtained, for example, by entering the words in any of the text input controls 110a and 110b. For example, a value (or candidate keyword) entered in the text input control 110a that results in obtaining several additional pertinent pages 112 is considered “more important” than a value that results in no additional pages 112.

The FPM 104 here includes a word reduction module 126 which can reduce the number of keywords being considered. In this implementation, the word reduction module 126 is included in the word extraction module 122. For example, the set of keywords can be reduced by removing any keyword that appears on too few (e.g., only one) or too many (e.g., 80% or more) subsequent pages 112 in the results set obtained from values entered in the text input controls 110a and/or 1 lob. The frequency of occurrences of keywords on the pages 112 can be measured, for example, by a frequency module 128, shown here as part of the word reduction module 126. The frequency module 128 can use thresholds, such as a minimum or maximum number (or percentage) of occurrences of words on form pages. Using such thresholds, the frequency module 128 can narrow the set of candidate keywords to keywords that retrieve the most useful of the pages 112.

A clustering module 130, shown here as part of the word reduction module 126, can cluster keywords based on, for example, their association with page signatures. For instance, keywords such as “car” and “automobile” may be clustered if they result in the same or similar information being retrieved. In some implementations, keywords are clustered if they occur on the same ones of the pages 112. The word reduction module 126 can use keyword clusters created by the clustering module 130 to eliminate redundant keywords. For example, when several keywords are part of the same keyword cluster, the word reduction module 126 (and the system 100 in general) can randomly select one of the keywords for further processing.

The word reduction module 126 can include a page signature module 132 that can compute a page signature for each web page in the generated collection of pages 112. For example, the page signature of a page 112 can include information regarding the content of the web page, its size (e.g., as measured in bytes of HTML), and/or any other information about the page. A web page's signature can be used to determine the web page's distinctness. Multiple pages 112 can have the same or very similar page signatures if, for example, the web pages contain the same information simply rearranged in a different order. Page signatures determined by the page signature module 132 can be independent of the advertising that may appear on each page, as ads for similar web pages (or the same web page) can vary for different reasons. The word reduction module 126 can use the page signature module 132 to determine, for example, which values entered in text input controls 110a and 110b provide significantly different results. The word reduction module 126 can use page signature information in various ways, such as to reduce superfluous keywords.

The FPM 104 can include a typed values module 134 that can determine the types of values associated with the form pages 106 and pages 112. Specifically, the typed values module 134 can determine values that can be used for various fields, such as the text input controls 110a and 110b. The determination can depend at least in part on whether the text input control is associated with a generic or typed input field. For example, if the text input control 110a is a simple text entry box or field, then it may be a generic field, generally accepting any free-form input. In this case, any keyword can be used for the field. In some implementations, the typed values module 134 is generally not used with generic inputs. In another example, if the text input control 110b is a typed field for U.S. states, then the valid entries for the text input control 110b include state identifiers such as 2-character U.S. state abbreviations.

The typed values module 134 can use a set of value domains 136. For example, various value domains can exist or be created for words associated with cars, public records, real estate, etc. As such, particular types of values can constitute valid entries for fields associated with particular value domains. While some values associated with the text input controls 110a and 110b may be unique to a particular value domain, other value types (e.g., ZIP code) can be used as an input in several domains. Each of the value domains 136 can define the domain of valid values associated with a particular value type. For example, a value domain for the automobile industry may define manufacturer name values (e.g., Ford, Chevrolet, etc.) used for the “make” of an automobile, and each “make” may have a set of valid models (e.g., Mustang, etc.). The FPM 104 can use information from the value domains 136 to determine values that can be used in fields on the form, such as on the text input controls 110a and 110b.

Information in the value domains 136 can be obtained from available public sources, such as lists from online repositories that provide such information. In some implementations, the FPM 104 can add new value domains 136 or modify existing ones. For example, if the FPM 104 is processing a form page 106 that contains a heading “Select an XYZ” above a text entry box, a new value domain 136 named “XYZ” can be added. Also, values for the new domain would represent the possible entry options associated with the data entry area. Such values in the domain can be reduced (for example as will be described in detail below) by removing any values that are, for example, less informative.

The FPM 104 can create one or more indexing records 138 based on its analysis. An indexing record can indicate values such as keywords that are good to use for either or both of the text input controls 110a and 110b. For example, the indexing record 138 can include URLs for any of the pages 112 that the FPM 104 found to be sufficiently distinct to justify indexing, each of the URLs containing one or more keywords determined to be informative. In contrast, URLs for those pages that were found to be identical or substantially similar to other pages may be deliberately omitted, or deleted, from the indexing record 138.

The system 100 includes an indexing module 140 that can be configured to retrieve and index content from any of the pages 112 based on the indexing record 138. For example, when the indexing record 138 includes URLs of pages to be indexed, the indexing module 140 can access the URLs and use them to retrieve the corresponding pages. The indexing module can then store results of the indexing according to its specifications, for example to provide an index to be used by a search engine. In some implementations, the FPM 104 can update or modify the indexing record(s) 138 one or more times, and this can provide the indexing module 140 with more up-to-date information of which of the pages 112 are to be retrieved.

The indexing information that the indexing module 140 updates in the indexing records 138 can include keywords relating to the text input controls 110a and 110b. For example, if an automobile manufacturer's name such as “Ford” is entered in the text input controls 110a and 110b and pages 112 that are useful for indexing are obtained as a result, the indexing records 138 can record that keyword (e.g., “Ford”) as one that may be good to use for indexing pages under the form page 106.

The system 100 includes a search engine 142 that is configured to identify pages that satisfy search criteria. In some implementations, the computer network 102 can be the internet and the search engine 142 can identify web pages. In one example, the search engine 142 can identify pages 112 corresponding to inputs on the form page 106, such as keywords entered in the text input controls 110a and 110b. In some implementations, the search engine can retrieve pages using URLs construed to include one or more keywords for the input control(s) on the form page 106. This can be done when the keywords are being subjected to an informative property evaluation or when pages are retrieved using informative keywords, to name just two examples. As such, the search engine 142 can aid in determining the informative property of the keywords and/or in the indexing of pages.

The following is an example of how the FPM 104 can retrieve those of the pages 112 that correspond to a particular setting of the text input controls 110a and 110b. An HTML form can include an action that identifies the server and the program that processes the form submission and the result page generation. An HTML form can also have a series of inputs that can be of various types, e.g., select menus, text boxes or other text input controls, radio buttons, check boxes, etc. Consider, for example, GET forms according to the HTML nomenclature. For GET forms, upon submission, a URL of the form

action?i₁=v₁&i₂=v₂& . . . &iₙ=vₙ

is created, where “action” is the action of the form, “i₁”, “i₂”, . . . “iₙ” are the names of the inputs and “v₁”, “v₂”, . . . , “vₙ” are the values submitted for the inputs. HTML submissions can also include hidden inputs and/or submit inputs. Such inputs and their values can be appended to the end of the generated URLs.

HTML forms can be filled out by creating mappings between schemas and inputs in HTML forms. Schemas can be created for each domain and can contain attributes and values that are pre-defined for each attribute. A mapping from a form input to an attribute can identify the values that can be filled into that input. Other examples of filling out online forms are discussed in pending patent application Ser. No. 11/399,568, filed Apr. 5, 2006 and entitled “Searching through content which is accessible through web-based forms”, the entire contents of which are hereby incorporated by reference.

The possible input values available for any and all of the text input controls 110a and 110b can be determined in any of a number of ways. For example, these text values can be obtained by extracting text from the form page 106 and/or as described in the pending patent application Ser. No. 11/399,568. Accordingly, in some implementations, at least one of the text input controls 110a and 110b can be configured to receive text string input. In such examples, the FPM 104 can generate URLs for retrieving pages by formulating at least one text string input value for such an input control.

A description follows regarding how input values can be generated for forms in order to determine keywords that can be indexed from the resulting target pages. The description includes approaches and algorithms that can be used by the system 100. The description also includes results of experiments using such procedures.

A large number of Hyper Text Markup Language (HTML) forms have text boxes. In addition, some forms with select menus require valid values in their text boxes (or text input controls) in order to retrieve any results.

Text boxes can be used in at least two different ways in forms. In the first, the inputs into a text box are fed into an Information Retrieval (IR) engine to find documents containing that word. Common examples of this case are searching for books by title or author. In the second, a text box can be a source of values used in the WHERE clause of a query over a back-end database similar to the role of a menu. The values can either correspond to a well-defined finite set (e.g., ZIP codes or state names in the U.S.), or they can be instances of a continuous data type (e.g., positive numbers for prices or integer triples for dates). For the purposes of this disclosure, this underlying distinction induces a division of text boxes into two types: generic and typed. Invalid entries in typed text boxes generally lead to error pages, and hence it is important to identify the correct data type. Given the nature of IR engines, badly chosen keywords in generic text boxes can still return some results, and hence the challenge lies in identifying a finite set of keywords that extract a diverse set of result pages.

In an example approach that can be used by the system 100 that follows, an algorithm to generate a set of keywords for a generic text box is described first. An experimental evaluation of the performance of the algorithm is then presented. Then, a description follows regarding how typed text boxes can be identified when keywords cannot be generated, and it is demonstrated that there is potential in developing recognition techniques for such types of boxes.

First, consider the problem of identifying good candidate keywords for generic text boxes. Conceivably, the approach can design word lists in various domains to enter into text boxes. However, one can quickly realize that there are far too many concepts and far too many domains. Furthermore, for generic text boxes, even if the approach identifies inputs in two separate forms to be the same concept in the same domain, it is not necessarily the case that the same set of keywords will work on both sites. The best keywords often turn out to be very web site specific. Since one goal of the approach can be to scale to millions of forms and multiple languages, a simple, efficient and fully automatic technique can be desirable.

The system 100 can adopt an iterative probing approach to identify the keywords for a text box. Rather than starting from a dictionary of terms, the system 100 can use the form site itself as a source for keywords. Specifically, the system 100 can start with an initial seed set of words extracted from the form page. Just as with any other singleton input tuple, the approach generates URLs assuming the seed set of keywords to be the values. In addition to analyzing the informative property of generated URLs, the system 100 can extract new keywords from the contents of the result pages. If the approach is able to discover any new keywords, the system 100 can repeat the above process assuming the new keywords to be values for the text box. The system 100 can continue the probing procedure until either the procedure is unable to extract any new keywords or some predefined termination condition is met (e.g., a maximum number of candidate keywords are extracted or a maximum number of iterations have occurred). Once the iterative probing terminates, a subset of the entire set of all extracted candidate keywords is chosen. An example overall approach used by the system 100 to identify good candidate keywords for generic text boxes is now described in detail.

The system 100 can extract the initial seed set and new keywords from the generated web pages by trying to identify the most relevant words on the pages. For this, the system 100 can use the popular Information Retrieval measure Term Frequency-Inverse Document Frequency (TF-IDF). Briefly, the TF (term frequency) measures the importance of the word on that particular web page. Suppose a word w occurs n_{w,p} times on a web page p and there are a total of Nₚ terms (including repeated words) on the web page, then

tf(w,p)=n_{w,p}/Nₚ.

The IDF (inverse document frequency) measures the importance of the word among all possible web pages. Suppose w occurs on d_{w} web pages, and there are a total of D web pages in the search engine index, then

idf(w)=log D/dw.

TF-IDF balances the word's importance on the page with its overall importance and is given by

tf idf(w,p)=tf(w,p)×idf(w).

The system 100 can pick the seed set by selecting the top Nᵢₙᵢₜᵢₐₗ words on the form page sorted by their TF-IDF scores. To select new candidate keywords for iteration i+1, suppose that Wᵢ is the set of all web pages generated and analyzed until iteration i. Let Cᵢ be the set of words that occurs in the top N_{probe} words on any page in Wᵢ. From Cᵢ, the system 100 can eliminate words if they have already been proved. Alternatively, the system 100 can eliminate words if they have so far occurred in too many of the pages in Wᵢ (e.g., 80%), since they are likely to correspond to boiler plate HTML that occurs on all web pages on the form site (e.g., menus, advertisements, contact information, etc.). Further, the system 100 can eliminate words if they occur on only one page in Wᵢ, since they can be nonsensical or idiosyncratic words that are not representative of the contents of the form site.

The remaining keywords in Cᵢ are the new candidate keywords for iteration i+1. The choice of Nᵢₙᵢₜᵢₐₗ and N_{probe} determines the aggressiveness of the algorithm. By choosing lower values, the system 100 might not be able to extract sufficient keywords, but very high values can result in less representative candidate keywords. Experiments can indicate Nᵢₙᵢₜᵢₐₗ=50 and N_{probe}=25 to be good values.

On termination, there potentially can be a very large set of candidate keywords. However, in order to limit the number of URLs generated from the form, the system 100 can place limits on the maximum number of keywords for a text box. The system 100 ideally would like to choose the subset that provides the most Deep Web coverage of the form site. Sophisticated schemes such as modeling the selection as an approximate set cover problem can be considered. In the interest of simplicity and efficient application across millions of forms, the approach used by the system 100 can use a much simpler strategy. Candidate keywords can first be clustered based on the page signature of the corresponding web page. The similarity in signatures can indicate similar contents, and hence the system 100 can randomly select one of the candidate keywords from each cluster. The chosen candidate keywords can be sorted based on the length of the corresponding web page, and the final set of keywords can be selected in descending order. The intuition underlying this strategy is that longer pages are likely to have more results, and hence the system 100 might be able to get more coverage for the same number of keywords. This simple selection scheme has been found to work well in practice.

It can be noted that placing a single maximum limit on the number of keywords per text box may be unreasonable because the contents of form sites can vary widely from a few tens to millions of results. The system 100 can use a back-off scheme to address this problem. For instance, the system 100 can start with a small maximum limit per form.

Over time, the system 100 can measure the amount of search engine traffic that is affected by the generated URLs. If the number of impressions is high, then the system 100 can increase the limit for that form and restart the probing process.

Other iterative probing algorithms can be used for extracting documents from text databases. In some implementations, the system 100 can use a technique in which words in a dictionary (or other source) are scored based on their probabilities of occurrence in text documents retrieved from the result pages. The text documents can be hyperlinks from the result pages. It is noted that not all Deep Web sources are text databases. Moreover, practical considerations can make it harder to apply such an algorithm in the context of the system 100. Specifically, a large number of form sites, especially in product search, can have the database records directly on the result pages rather than being clearly identified hyperlinks to text documents. Hence, extraction rules can be written (or inferred) on a per-site basis to identify the URLs on the result pages that correspond to text documents. More importantly, since one goal of the system 100 can be not to necessarily extract all the contents of specific form sites, it can be advantageous to trade off potentially lower coverage for increased efficiency.

The following paragraphs describe experimental results using the approach of system 100. HTML forms can have multiple text boxes. In experiments, only one text box per form is considered. Based on a manual analysis, it is believed that in a large fraction of forms, the most likely generic text box is the first text box in the form. Hence, experiments can apply the probing approach to the first text box. In all, the iterative probing approach is able to select keywords for 30% of the forms that have at least one text box. Some of the reasons for failure are the same as in the case of select-menu only forms. A further reason for failure in this case is due to typed text boxes.

In the experiments below, the approach considers a different dataset of 500,000 HTML forms from which keywords are generated. For each form, the approach tries to select 500 keywords. The iterative probing approach is implemented as described above. The approach stops extracting candidate keywords either after 15 iterations, or once 1500 candidates for keyword selection have been extracted, whichever occurs first. More than 500 keywords are extracted in order to provide a larger and potentially more diverse set of candidate keywords from which to select. For instance, stopping the iterations pre-maturely at 500 might result in only exploring one small section of the form site.

During keyword generation, as described above, iterative probing can terminate due to one of three reasons: (1) for 70% of the forms no new keywords can be extracted after a few iterations, (2), for 9% of the forms the maximum number of iterations is reached, and (3) for the remaining 21% termination occurs once sufficient keywords have been extracted and tested to enable the eventual selection of the 500 keywords. FIG. 1A shows an example distribution histogram 150 of HTML forms by the number of keywords selected for each form. The distribution histogram 150 can be constructed by bucketing forms based on the number of keywords selected. Two observations can be made. First, there are no forms with 0-20 keywords in this example because the system 100 can consider text boxes with fewer than 20 extracted keywords to be uninformative. These text boxes are unlikely to be generic search boxes. Second, the number of forms in the last bucket is significantly more because it groups all forms with 500 or more candidate keywords into a single bucket.

More interestingly, it is noted that if the two extreme buckets (30 and 500+ keywords) are excluded, the shape of the distribution histogram 150 resembles a power-law distribution, specifically the Zipf distribution. The large 500+ bucket corresponds to the heavy tail of the Zipf distribution. The log-log plot of the distribution histogram 150 (log of number of forms against the log of number of keywords) is very close to a straight line. Based on this observation, a hypothesis can be that the number of keywords that can be extracted for text boxes on the WWW has a Zipf distribution. Further, if it is assumed that the number of keywords extracted for a form is directly proportional to the size of the back-end database supporting the form site, then the size distribution of web databases can be hypothesized to be Zipfian. Aside from being the first time such an observation has been made about the nature of content on the Deep Web, it also suggests that putting any limit on the number of keywords that the system 100 extracts would leave out a significant amount of content.

FIG. 1B shows an example database coverage table 160 that relates text boxes on forms with URLs obtained using the text boxes. More specifically, the table 160 lists examples of HTML forms with text boxes comparing to the actual size of the database (number of records) against the number of URLs generated and the number of records retrieved: (first) on the first results page when using only the text box, (first++) on the first page and the pages that have links from it when using only the text box, and (select) on the first page using only select menus on the same form.

The table 160 lists examples of real form sites whose size was possible to determine either by inspection of by submitting a carefully designed query. The table 160 shows the performance of the algorithm in extracting keywords for the sites. In each of these examples, a maximum of 500 keywords were selected for the first text box in the form. The algorithm can consider the URLs generated using the selected keywords for the text box and default values for all other inputs. To estimate the coverage, the number of database records retrieved can be counted by manually inspecting the site to determine patterns that identify unique records on the result web pages.

First, the algorithm can consider only the contents on the first results page (column first in the table 160), since these correspond directly to the generated URLs. It is observed that in examples 1 and 2, when the databases are small (e.g., less than 500 records), the algorithm is able to reach almost all database records. Further, the algorithm can terminate with fewer keywords than the estimated database size. As the estimated database sizes increase (examples 3 to 8), the algorithm can stop at 500 selected keywords, and the algorithm is only able to get to a fraction of the total records. In general, while the absolute number of records retrieved increases, the fraction retrieved decreases. Not surprisingly, the algorithm can get to more records when there are more results per page. As already highlighted, the algorithm can work in all languages (e.g., example 9 in the table 160 is a Polish site, while 10 is a French one). In all, the results in FIG. 1B include forms in 54 languages.

Second, given the generated URLs, the search engine web crawler will automatically (over time) pursue some of the outgoing hyperlinks on the corresponding web pages (e.g., follow the Next links). Hence, in order to get an estimate of the database coverage assuming such a crawling pattern, the algorithm also includes the web pages that are outlinks from the first result page (column first++ in the table 160). As can be seen, the coverage is much greater. Observe that while in example 7, the coverage only doubles, but in example 9 it is significantly more. This is because in the former, there is only a single Next link, while in the latter, there are links to multiple subsequent result pages.

The last column in the table 160 shows the number of results obtained from considering only select menus in the forms. The table 160 shows that the coverage of the select menus is much smaller, therefore it is important to consider both select menus and text boxes. It is important to note that the records extracted from text boxes did not necessarily subsume the ones extracted from select menus.

Along the same lines, it may be of interest to compare the relative contribution of URLs generated from text boxes and those generated from select menus to the resulting query traffic. The approach can count the number of times the URLs appear in the first 10 results for some query on the search engine. The approach can consider the 1 million forms in the datasets. The URLs generated can fall into three categories: those generated using input tuples having (1) only one text box, (2) one or more select menus, and (3) one text box and one or more select menus. Overall, it can be found that URLs in these categories contribute to search results in the respective ratios <0.57, 0.37, 0.06>. The ratios are <0.30, 0.16, 0.54> when attention is restricted to forms that generated URLs from both text boxes and select menus. Clearly, the approach can benefit from considering text boxes, select menus and their combinations.

An example of an algorithm for detecting typed text boxes is now described. Experience can suggest that there are relatively few types that, if recognized, can be used to index many domains, and therefore appear in many forms. For example, the type “ZIP code” is used as an input in many domains including cars, public records and real-estate, and the type “date” is used often as an index of many domains, such as events and articles archives. An experiment that validates this intuition is now described.

Two important ideas can be utilized, to name some examples. First, a typed text box may produce reasonable result pages only with type-appropriate values. The system 100 can use this idea to set up informative property tests using known values for popular types. The system 100 can consider finite and continuous types. For finite types (e.g., ZIP codes and state abbreviations in the U.S.), the system 100 can test for informative properties using a sampling of the known values. For continuous types, the system 100 can test using sets of uniformly distributed values corresponding to different orders of magnitude. Second, popular types in forms can be associated with distinctive input names. The system 100 can use such a list of input names, either manually provided or learned over time, to select candidate inputs on which to apply informative property tests.

The following experiment was conducted with four types: U.S. ZIP codes, U.S. city names, prices and dates. For price, the experiment considered two sub-types, price-small (0-5,000) and price-large (50,000-500,000), with the former targeting product sites and the latter real-estate sites. The experiment considered a random selection of about 1400 forms. Of these forms, about 200 forms have a text box input whose name match the pattern *city*, *date*, *price*, and *zip*, i.e., contain the terms city, date, price, etc. For each of these forms the experiment considered the first text box and other text boxes whose name contains any of the mentioned terms. On each of the selected inputs, the experiment performed the informative property tests for all the chosen types as well as an informative property test as generic text box (using words selected from the form page).

The following table shows the results of the experiment:

Detecting Input Type Table

| | *city* | *date* | *price* | *zip* | * |
|---|---|---|---|---|---|
| city-us | 60 | 6 | 4 | 14 | 113 |
| date | 3 | 46 | 12 | 8 | 7 |
| price-small | 3 | 6 | 40 | 4 | 18 |
| price-large | 2 | 8 | 34 | 0 | 12 |
| zip-us | 4 | 2 | 13 | 136 | 3 |
| generic | 8 | 0 | 2 | 3 | 392 |
| none | 92 | 295 | 369 | 111 | 300 |
| total | 172 | 363 | 475 | 276 | 845 |

Each entry in the table records the results of applying a particular type recognizer (e.g., corresponding to rows city-us, date, etc.) on inputs whose names match different patterns (columns, e.g., *city*, *date*). The “*” column includes inputs that do not match any of the patterns. Likewise, the row “none” includes inputs that are not recognized by any of the identifiers.

The type recognized for an input is the one that has the highest distinctness fraction. However, none of the types are deemed recognized if the best distinctness fraction is less than 0.3.

Distinctness fractions can be defined relative to being informative (e.g., informative input tuples) with respect to a threshold r. Let T be an input tuple in a form and Sig be a function that computes page signatures for HTML pages. Let G be the set of all possible URLs generated by the input tuple T and let S be the set {Sig(p)|pεG}. We say that T is an informative tuple if |S|/|G|≧r. Otherwise we say that T is uninformative. The ratio |S|/G| is called the distinctness fraction.

The table shows that when recognitions represented by the “none” row are excluded, it is found that the vast majority of type recognitions are correct. The following observations can also be made. First, some *price* inputs get recognized by zip-us. This is not surprising, since ZIP code values being integers are valid entries for price. Second, some *zip* inputs get recognized by city-us, and some *city* inputs get recognized by zip-us. On closer inspection, these inputs turn out to be ones that accept either city names or ZIP codes for location information. Third, a number of “*” inputs get recognized by city-us. This turns out to be the case because these inputs are generic search boxes, and city names are after all English words that seem work well for those sites. Fourth, *date* inputs are particularly hard to recognize, since there are multiple possible date formats, and because only one date format (mm/dd/yy) is used, not as many inputs are recognized. Experimenting with multiple candidate formats can likely improve performance. Lastly, it is found that the informative property test can identify input names associated with specific types (e.g., the 3 “*” inputs recognized by zip-us have the name “postal code”).

The results seem to indicate that text box types can be recognized with high precision. It is also found that, of all the English forms in the web index that are believed to be hosted in the U.S., as many as 6.7% have inputs that match the patterns mentioned above. This can lead to a conclusion that a degree of type-specific modeling can play an important role in expanding Deep Web coverage. Recent work on understanding forms can potentially be leveraged to identify candidate inputs for domain specific types that can then be verified using the informative property test.

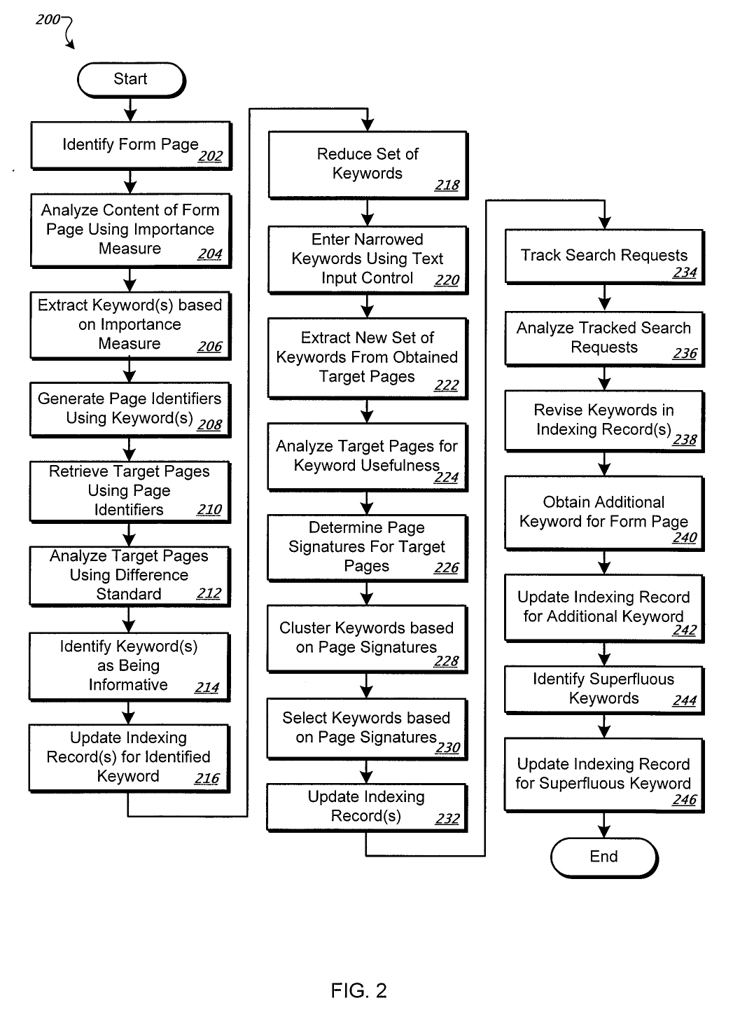

FIG. 2 shows a flow chart of an example method 200 for analyzing a form page for indexing. The method 200 can be performed by a processor executing instructions in a computer-readable medium, for example in the system 100.

As shown, method 200 includes a step 202 of identifying a form page. The form page is configured for use in requesting any of multiple target pages. The form page includes at least one text input control for retrieving any of the multiple target pages. For example, the FPM 104 can identify the form page 106 relating to an automotive manufacturer, the page 106 including the text input controls 110a and 110b and being associated with the pages 112. The form page 106 may be, for example, a web page that a user can reach (e.g., via a Web browser) by searching the web for information about cars or some other subject.

Method 200 includes a step 204 of analyzing content of the form page using an importance measure. For example, the FPM 104 can analyze the contents and fields on the form page 106, such as the text input controls 110a and 110b and other information, and determine importance measures for each. Specifically, particular content (or fields) may be very specific to cars (and may be analyzed as being important) or the content may include text areas that are less specific to cars (and are analyzed as being less important). As another example, the form page can be analyzed to determine whether any or all of the text input controls is or are informative with regard to the underlying pages.

Method 200 includes a step 206 of extracting keyword(s) based on the importance measure. Specifically, the keywords extracted can include any word in the content that satisfies an importance criterion of the importance measure. For example, the keywords can include keywords from any of the value domains 136 that correspond to the text input controls 110a and 110b. The keywords that are extracted can be the ones that meet one or more pre-defined importance criteria.

Method 200 includes a step 208 of generating a first set of page identifiers. Each of the page identifiers includes at least one of a number of keywords. For example, the first set of page identifiers can be URLs for some or all of the pages 112 that are accessible from the form page 106. The specific URLs can depend on the keywords selected based on importance measure. Some of the URLs can be generated for a specific keyword (e.g., a valid value for either of the text input controls 110a and 110b). Other URLs can include keywords relating to both the text input controls 110a and 110b.

Each page identifier has a different value for at least a first one of multiple input controls. For example, the FPM 104 can generate URLs with different values (e.g., values j1, . . . , jn) for an input control that relates to selecting the vehicle model at a car manufacturer's site.

Method 200 includes a step 210 of retrieving any of the multiple target pages that are obtained using any of the generated first set of page identifiers. For example, the system 100 can retrieve the pages 112 corresponding to the URLs of the multiple target pages. If the URLs relate to cars, for example, the target pages retrieved can be the car-related web pages accessible by entering specific keywords on the form page 106.

Method 200 includes a step 212 of analyzing the retrieved target pages using a predefined difference standard. For example, the FPM 104 can perform the difference determination 116 to evaluate whether any of the retrieved pages 112 satisfy the standard 118.

In some situations, the analysis in step 212 indicates that the retrieved target pages do not satisfy the difference standard. An indexing record can then be updated to reflect that the used keyword or keywords are not informative with regard to requesting the multiple target pages. For example, the FPM 104 can omit the corresponding URLs from the indexing record 138 or otherwise note therein that the particular input control being tested has been deemed not informative.

In some situations, the analysis in step 212 indicates that the retrieved target pages satisfy the difference standard. An indexing record can then be updated to reflect that the used keyword is informative with regard to requesting the multiple target pages. For example, the FPM 104 can include the corresponding URLs from the indexing record 104 or otherwise note therein that the particular input control being tested has been deemed informative.

In some implementations, for a form page that accepts at least k keywords as input values, the FPM 104 can seek to determine if each keyword for the input controls is informative or not. For example, the informative property of a keyword can be tested by comparing the page it produces with one or more of those obtained for other already known keywords.

Method 200 includes a step 214 of identifying at least one keyword as being informative. Specifically, the keyword is identified as being informative with regard to the text input control. For example, if a keyword used in one of the text input controls 110a and 110b results in obtaining a distinct target page, the keyword can be identified as being informative.

Method 200 includes a step 216 of updating an indexing record associated with the form page to reflect the identified keyword. For example, the FPM 104 can create and/or update the indexing record 138 for the form page 106 by including therein the informative keywords. In some implementations, the indexing record is provided with URLs of those pages that are to be included in the next indexing operation.

Method 200 includes a step 218 of narrowing down the set of keywords. In some implementations, a new set of keywords can be obtained by reducing the set of keywords. Specifically, the reduced set of keywords is identified as being informative (e.g., more informative than the un-reduced set of keywords) with regard to requesting the multiple target pages. For example, the system 100 can obtain a new set of keywords by submitting the form page 106 using a subset of the current keywords. Specifically, the keywords may be part of the set of keywords in the current iteration, but the system 100 can determine what target pages 112 appear using various subsets or combinations of the keywords.

In some implementations, keyword(s) not leading to identification of new keywords can be eliminated. Specifically, a keyword can be eliminated if the obtained page resulting from the keyword does not produce any new keyword that is not already included in the number of keywords. For instance, during the iterative process of obtaining pages 112 using keywords, a set of pages 112 may not have any new keywords that are not already known to the system 100. If so, the system 100 can eliminate any keyword(s) that led to indistinct new pages 112.

In some implementations, the narrowing is performed in one or more iterations. Each iteration can reduce the set of keywords obtained in the previous iteration. The iterative process can be used to remove superfluous keywords from consideration if the keywords are shown, for example, to appear in too many or too few target pages 112.

Method 200 includes a step 220 of entering the narrowed set of keywords using, for example, the text input control of the form page. For example, using the set of keywords narrowed from a previous iteration, the FPM 104 can enter the narrowed set of keywords into the text input controls 110a and 110b.

Method 200 includes a step 222 of extracting a new set of keywords from at least one of the multiple target pages obtained in response to entering the narrowed number of keywords. For example, based on the new set of target pages 112 obtained using the reduced set of keywords, the iterative process can again extract keywords. Such keywords may, for example, appear on some of the target pages 112 and may not be already part of the set of keywords.

Method 200 includes a step 224 of analyzing the multiple target pages for keyword usefulness. The target pages analyzed are those obtained using each of the keywords. For example, the system 100 can analyze the pages 112 that are obtained using the keywords entered in the text input controls 110a and 110b. In some implementations, one or more of steps 218-224 can be performed before the indexing record is updated (step 216).

Method 200 includes a step 226 of determining multiple page signatures for target pages. In particular, one page signature is determined for each of the multiple target pages obtained using any of the number of keywords. For example, for each of the pages 112 that are obtained, the FPM 104 can analyze the HTML code and/or textual content of each page as described above.

Method 200 includes a step 228 of clustering each of the set of keywords based on the page signatures. The keywords can be clustered, for example, based on their association with page signatures. For instance, the clustering module 130 may cluster keywords (e.g., “car,” “automobile,” etc.) if they occur on the pages 112 having similar page signatures.

Method 200 includes a step 230 of selecting the set of keywords based on the page signatures. For example, the system 100 can select keywords that result in pages 112 having unique page signatures, while disregarding (or not selecting) keywords that lead to pages 112 that are repetitive or redundant, and therefore uninformative. In some implementations, one or more of steps 226-230 can be performed before the indexing record is updated (step 216).

Method 200 includes a step 232 of updating indexing record(s) associated with the form page to reflect the identified set of keywords or a modified set of keywords. The resulting indexing record(s) can be used over a period of time by a search engine performing searches for users. For example, for each of the pages 112 that the system determines to be informative, the indexing function 140 can update the indexing records 138. As such, users using those keywords, for example to search for content on the Web, can receive in their search results the pages 112 (which are part of the Deep Web) from the search engine 142.

Method 200 includes a step 234 of tracking any search requests received by the search engine that implicate any of the set of keywords. For example, over time the system 100 can track user searches that implicate the keywords that are indexed for Deep Web content. In one implementation, the search engine 142 can maintain counts of searches using one or more of the keywords.

Method 200 includes a step 236 of analyzing the tracked search requests. For example, the system 100 can periodically analyze the frequency each of the keywords has been implemented in a web search (e.g., entered as a search term in a user's Web browser). Such frequencies can be compared to thresholds, such as minimum number of implicating searches that justify maintaining a particular keyword in the indexing records 138.

Method 200 includes a step 238 of revising the set of keywords reflected in the indexing records based on the analysis of the tracked search requests. In some implementations, the system 100 can remove keywords from the indexing records 138, for example if the keywords are used infrequently in searches (e.g., by comparing to a minimum threshold).

Method 200 includes a step 240 of obtaining at least one additional keyword for the form page that is not included in the set of keywords. Such additional keywords can be identified following an analysis that shows that more than a threshold portion of the set of keywords are implicated by the search requests. For example, if the analysis of the tracked search requests indicates that pages generated using the generated keywords appear frequently in search results, then in response one or more additional keywords can be learned for that form page and added to the indexing record. As part of an iterative process, the system 100 can add the new keyword to the set of keywords to be used in the next iteration.

Method 200 includes a step 242 of updating the indexing records for the additional keyword. Specifically, the indexing records associated with the form page are updated to reflect the identified additional keyword. In this way, the indexing records can include a more complete set of keywords that are associated with the search results. For example, the system 100 can add the new keyword to the indexing records 138 corresponding to the pages 112 on which the keyword appears.

Method 200 includes a step 244 of identifying superfluous keywords. Identification of such keywords can be part of an analysis that shows that less than a threshold portion of the set of keywords are implicated by the search results. For instance, a particular keyword used to generate search results may occur too frequently (or too infrequently) to provide meaningful differentiation in the search results. As such, the word reduction module 126 can remove such superfluous keywords, such as any keyword that appears on too few (e.g., only one) or too many (e.g., 80% or more) of the pages 112.

Method 200 includes a step 246 of updating the indexing record for the superfluous keywords. Specifically, the indexing records associated with the form page are updated to reflect the identified superfluous keyword. In this way, the indexing records can include a more concise set of keywords that are associated with the search results, eliminating the insignificant keywords from the index. For example, the indexing module 140 can remove superfluous keywords from the indexing records 138.

Implementations can include fewer than all of the steps shown in FIG. 2. Implementations can have one or more steps performed in another order, for example as mentioned above.

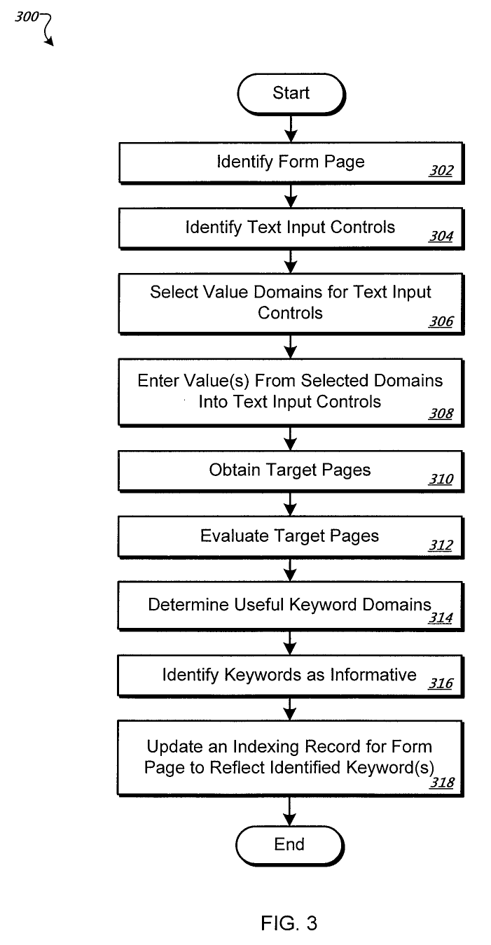

FIG. 3 shows a flow chart of an example method 300 for analyzing a form page for indexing. The method 300 can be performed by a processor executing instructions in a computer-readable medium, for example in the system 100. In some implementations, steps of the method 300 can be performed in parallel to the steps of the method 200 described above.

As shown, method 300 includes a step 302 of identifying a form page. The form page is configured for use in requesting any of multiple target pages. The form page includes at least one text input control for retrieving any of the multiple target pages. For example, the FPM 104 can identify the form page 106 relating to an automotive manufacturer, the page 106 including the text input controls 110a and 110b and being associated with the pages 112.

Method 300 includes a step 304 of identifying text input controls. For example, the system 100 can scan the form page 106 for text input controls, such as the text input controls 110a and 110b. Such text input controls can occur in different forms and can optionally include additional input controls, such as select menus, text boxes, radio buttons, check boxes, etc. The system 100 can identify text input controls, for example, by examining the HTML code that is used to generate a particular form page 106. For example, the FPM 104 can identify value domains 136 corresponding to the text input controls 110a and 110b.

Method 300 includes a step 306 of selecting keyword domains for the text input controls. The keyword domains include keywords that are all in a particular domain, such as zip codes and state names. The keywords can be entered in text input controls and the keyword domains can therefore be selected in order to identify keywords as being informative. For example, the FPM 104 can select value domains 136 corresponding to the text input controls 110a and 110b identified in step 304.

Method 300 includes a step 308 of entering keyword(s) selected from the plurality of types of keyword domains (e.g., in the text input control of the form page). For example, the FPM 104 can enter keywords into the text input controls 110a and 110b. The specific keywords entered can be from the value domains 136 associated with each individual text input controls 110a and 110b.

Method 300 includes a step 310 of obtaining target pages corresponding to the keywords entered on the form page. For example, the system 100 can obtain pages 112 in response to car-related keywords used on the form page 106. Specifically, the search engine 142 can use indexing records 138 to search for target pages 112 based on keywords entered in the text input controls 110a and 110b.

Method 300 includes a step 312 of evaluating at least one of the multiple target pages obtained in response to entering the narrowed number of keywords. For example, the keywords may have been entered in the text input controls 110a and 110b. The FPM 104 can use the relevancy criterion 120 in order to evaluate the target pages 112 obtained in step 310, such as to rate the retrieved target pages based 112 on distinctness. In another example, the FPM 104 can perform the difference determination 116 to evaluate whether any of the retrieved pages 112 satisfy the standard 118.

Method 300 includes a step 314 of determining, based on the evaluation, whether any of the plurality of types of keyword domains should be used as keywords for the form page. For example, the FPM 104 can determine, based on the distinctness of the evaluated target pages, which types of keyword domains should be used as keywords.

Method 300 includes a step 316 of identifying one or more keywords as being informative. Specifically, the keyword is identified as being informative with regard to entering the keyword in the text input control for requesting the multiple target pages. For example, if a keyword used in one of the text input controls 110a and 110b results in obtaining a distinct target page, the keyword can be identified as being informative.

Method 300 includes a step 318 of updating an indexing record associated with the form page to reflect the identified keyword(s). For example, the FPM 104 can create and/or update the indexing record 138 for the form page 106 by including therein the keywords and corresponding URLs of those pages that are to be included in the next indexing operation.

Implementations can include fewer than all of the steps shown in FIG. 3. Implementations can have one or more steps performed in another order. One or more steps from the method 300 may be performed in connection with one or more steps from method 200. For example, in some implementations, both portions of method 200 relating to processing a text input as a generic text input, and portions of method 300 relating to processing a text input as a typed text input, can be performed on the same text input. It can then be determined based on the results whether the text input should be treated as a generic text input or as a typed text input, and the keyword(s) can be identified accordingly.

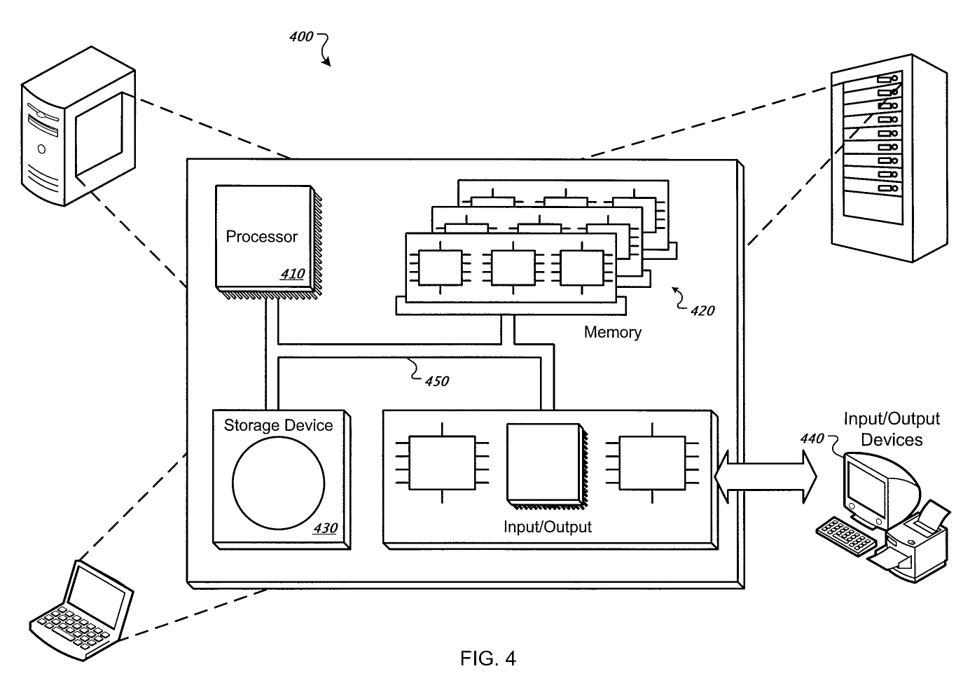

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 440. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

1. A computer-implemented method of analyzing a form page for indexing, the method comprising:
identifying a form page that is configured for use in requesting any of multiple target pages each having content associated with the form page, the form page including at least one text input control for retrieving any of the multiple target pages;
identifying multiple keywords to be used in page retrievals with regard to the form page;
performing the page retrievals, each involving at least one of the multiple keywords being entered in the text input control and at least one of the multiple target pages being received in response;
determining, for each received target page, a similarity of the received target page to each of multiple other target pages received in the page retrievals, wherein determining the similarity includes evaluating whether the received target page meets a difference standard with regard to each of the other target pages;
identifying, when the difference standard is met for at least a first target page with regard to each of the other target pages, at least a first keyword of the multiple keywords as leading to the first target page for which the difference standard is met; and
updating an indexing record associated with the form page to reflect the identified first keyword.

2. The computer-implemented method of claim 1, wherein identifying the first keyword comprises:
generating a first set of page identifiers, each of the page identifiers including at least one of a number of keywords;
wherein the first set of page identifiers is submitted as part of performing the page retrievals, the submission of each page identifier of the first set of page identifiers causing at least one of the keywords to be entered in the text input control.

3. (canceled)

4. The computer-implemented method of claim 2, wherein the analysis indicates that a second of the retrieved target pages obtained for a second keyword of the multiple keywords does not satisfy the difference standard relative to received target pages, and wherein the indexing record is updated to reflect that the second keyword is not informative with regard to requesting the multiple target pages.

5. The computer-implemented method of claim 1, where identifying the multiple keywords comprises extracting at least the first keyword from the form page.

6. The computer-implemented method of claim 5, wherein extracting the first keyword comprises:
analyzing content of the form page using an importance measure; and
extracting the first keyword from the content based on the first keyword satisfying an importance criterion of the importance measure.

7. The computer-implemented method of claim 1, wherein performing the page retrievals and identifying the first keyword comprise:
performing a first processing of the text input control as a generic text input control; and
performing a second processing of the text input control as a typed text input control;
wherein the identification of the first keyword is based at least in part on the first and second processings.

8. The computer-implemented method of claim 1, wherein the identification of the first keyword comprise an iterative process that includes at least two iterations.

9. The computer-implemented method of claim 8, wherein a previous iteration of the iterative process yielded a set of keywords, and wherein each iteration comprises:
narrowing down the set of keywords obtained in the previous iteration;
entering the narrowed set of keywords using the text input control of the form page; and
extracting a new set of keywords from at least one of the multiple target pages obtained in response to entering the narrowed set of keywords.

10. The computer-implemented method of claim 1, wherein a set of keywords, including the first keyword, is identified.

11. The computer-implemented method of claim 10, further comprising:
updating the indexing record associated with the form page to reflect the identified set of keywords, wherein the indexing record is used over a period of time by a search engine performing searches for users; and
tracking any search requests received by the search engine that implicate any of the set of keywords.

12. The computer-implemented method of claim 11, further comprising:
analyzing the tracked search requests; and
revising the set of keywords reflected in the indexing record based on the analyzing.

13. The computer-implemented method of claim 12, wherein when the analysis shows that more than a threshold portion of the set of keywords are implicated by the search requests, the method further comprises:
obtaining at least one additional keyword for the form page that is not included in the set of keywords; and
updating the indexing record to reflect also the at least one additional keyword.

14. The computer-implemented method of claim 12, wherein when the analysis shows that less than a threshold portion of the set of keywords are implicated by the search requests, the method further comprises:
updating the indexing record to reflect fewer than all of the identified set of keywords.

15. The computer-implemented method of claim 10, wherein a number of keywords were obtained before identifying the set of keywords further comprising:
obtaining the set of keywords including reducing the number of keywords.

16. The computer-implemented method of claim 15, wherein the number of keywords is reduced by:
analyzing those of the multiple target pages obtained using each of the keywords; and
eliminating any keyword for which the obtained pages do not produce any new keyword that is not already included in the number of keywords.

17. The computer-implemented method of claim 15, wherein the number of keywords is reduced including:
determining multiple page signatures, one for each of the multiple target pages obtained using any of the number of keywords;
clustering each of the number of keywords based on the page signatures; and
selecting the set of keywords based on the page signatures.

18. The computer-implemented method of claim 17, wherein the page signature includes information about a length of each of the multiple target pages obtained using any of the number of keywords, and wherein the set of keywords is selected in order of size beginning with one of the multiple target pages having a greatest length.

19. The computer-implemented method of claim 1, further comprising:
selecting a plurality of types of keyword domains before performing the page retrievals;
entering keywords selected from the plurality of types of keyword domains in the text input control of the form page;
evaluating at least one of the multiple target pages obtained in response to entering the selected keywords; and
determining, based on the evaluation, whether any of the plurality of types of keyword domains should be used as keywords for the form page in the page retrievals.

20. The computer-implemented method of claim 19, wherein at least one of the plurality of types of keyword domains includes a finite domain, and wherein the keywords are selected by sampling the finite domain.

21. The computer-implemented method of claim 19, wherein at least one of the plurality of types of keyword domains includes a continuous domain, and wherein the selected keywords are uniformly distributed in the continuous domain.

22. (canceled)

23. (canceled)

24. A system including memory and one or more processors operable to execute instructions stored in the memory, comprising instructions to:
identify a form page that is configured for use in requesting any of multiple target pages each having content associated with the form page, the form page including at least one text input control for retrieving any of the multiple target pages;
identify multiple keywords to be used in page retrievals with regard to the form page;
perform the page retrievals, each involving at least one of the multiple keywords being entered in the text input control and at least one of the multiple target pages being received in response;
determine, for each received target page, a similarity of the received target page to each of multiple other target pages received in the page retrievals, wherein determining the similarity includes evaluating whether the received target page meets a difference standard with regard to each of the other target pages;
identify, when the difference standard is met for at least a first target page with regard to each of the other target pages, at least a first keyword of the multiple keywords as leading to the first target page for which the difference standard is met; and
update an indexing record associated with the form page to reflect the identified first keyword.

25. The system of claim 24, wherein the instructions to identify the first keyword comprise instructions to:
generate a first set of page identifiers, each of the page identifiers including at least one of a number of keywords;
wherein the first set of page identifiers is submitted as part of performing the page retrievals, the submission of each page identifier of the first set of page identifiers causing at least one of the keywords to be entered in the text input control.

26. The system of claim 24, wherein the system further includes instructions to indicate that a second of the retrieved target pages obtained for a second keyword of the multiple keywords does not satisfy the difference standard relative to received target pages, and instructions to update the indexing record to reflect that the second keyword is not informative with regard to requesting the multiple target pages.
